(19) United States
(12) Patent Application Publication
(10) Pub. No.: US 2008/0046719 A1
(43) Pub. Date: Feb. 21, 2008

(54) Access point and method for supporting multiple authentication policies

(75) Inventors: Sung Jun Kim, Seoul (KR); Myeon Kee Youn, Incheon Metropolitan City (KR); Seong Kyu Song, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTONICS CO., LTD., Suwon-si (KR)

(21) Appl. No.: 11/725,189

(22) Filed: Mar. 16, 2007

(30) Foreign Application Priority Data
Aug. 18, 2006 (JP) 2006-77935

(51) Int. Cl. H04L 9/00

(52) U.S. Cl. 713/156

(57) ABSTRACT

An access point and a method supporting multiple authentication policies for a WLAN are disclosed. The access point according to the present invention includes an authentication policy detector for detecting an authentication policy of a terminal from a signal transmitted by the terminal, a plurality of authentication modules for performing the authentication procedures corresponding to different authentication policies, and an authentication processor for performing an appropriate authentication procedure by selecting the corresponding authentication module according to the authentication policy detected by the authentication policy detector. The access point and method for supporting multiple authentication policies according to the present invention avoid duplication of network elements for authentication by providing an authentication service for terminals using different authentication policies with a single access point.

This application claims priority under 35 U.S.C. §119 to an application entitled “ACCESS POINT AND METHOD FOR SUPPORTING MULTIPLE AUTHENTICATION POLICIES” filed in the Korean Intellectual Property Office on Aug. 18, 2006 and assigned Serial No. 2006-77935, the contents of which are incorporated herein by reference.

### BACKGROUND OF THE INVENTION

1. Field of the Invention

The present invention relates to an access point and a method for a wireless local area network (WLAN), and more particularly, to an access point and a method for supporting multiple authentication policies in a WLAN.

2. Description of the Prior Art

When transmitting data through a wireless network, transmitters of this data, for security purposes, may not want the transmitted data to be exposed to a third party. Whereas a wired network requires a physical connection for data reception, wireless data packets may be received by a third party who has a compatible receiver. A wireless communication system based on IEEE 802.11 utilizes a data cipher method to prevent data from being received by a third party.

The IEEE 802.11(i) standard defines a protocol modified from the IEEE 802.11 standard, and specifies a security mechanism for a wireless network. The IEEE 802.11(i) standard discloses a Robust Security Network (RSN) having an improved cipher capability in authentication security. The IEEE 802.11i standard defines RSN and pre-RSN classes as two security frameworks for the IEEE 802.11 WLAN. A terminal enabling RSN Association (RSNA) is called an RSN equipment.

IEEE 802.11i utilizes IEEE 802.1X for authentication and key management services. IEEE 802.11i integrates an IEEE 802.1X port and an Authentication Server (AS) as two elements in an IEEE 802.11 structure. The IEEE 802.1X port enables connection between two terminals, and provides 1:1 mapping for connection with the IEEE 802.1X port.

In order to improve confidentiality, the IEEE 802.11i utilizes an advanced cipher algorithm of a Counter-mode/CBC-MAC Protocol (CCMP) and an advanced cipher algorithm of a Temporal Key Integrity Protocol (TKIP). CCMP is essential for RSN, but TKIP is selectively used for pre-RSN equipments.

WLAN may operate in an Extended Service Set (ESS) mode or in an Independent Basic Service Set (IBSS) mode. The ESS mode is generally used as a part of a network for the connection to a wired LAN, having terminals, access points (APs), and wired LAN interfaces. Wireless terminals are equipped with a Network Interface Card (NIC) for interfacing the terminals with the access points through Radio-Frequency (RF) transmission.

Another mode of WLAN is configured with an independent RF network having only terminals. This mode is an independent WLAN which is commonly known as an adhoc or IBSS mode.

The ESS mode is configured with a plurality of Basic Service Sets (BSS). The BSS mode is configured with an access point and a plurality of terminals. The access point advertises a Service Set Identifier (SSID) of ESS and RSN capability by using an associated RSN Information Element (IE), and terminals advertise RSN capability by using their RSN IE.

An access point for managing one BSS determines whether to allow or restrict access trials of all terminals. The access point compares a parameter value required by the BSS with a parameter value of a terminal, and verifies use of security policy and available cipher mechanism. If the security policy used by the terminal differs from the security policy of the access point, the access point denies access by the corresponding terminal to a network.

FIG. 1 is a block diagram illustrating a conventional BSS configured with an access point and a plurality of terminals, and illustrates an example in which an access point for managing the BSS performs user authentication and key management by using TKIP and 802.1X extended authentication protocol (802.1X EAP).

Referring to FIG. 1, the BSS is configured with an access point 110 and first to fifth terminals (121 to 125). The access point 110 performs user authentication and key management by using TKIP and 802.1X EAP. The first terminal 121 uses WEP-40 (Wired Equivalent Privacy-40), the second terminal 122 uses TKIP and 802.1X EAP, the fourth terminal 124 uses WEP-104, the fifth terminal 125 uses CCMP and 802.1X, and the third terminal 123 does not use a security policy. In this case, the access point 110 denies access by terminals 121, 123, 124, and 125 to the network, and permits access only to the second terminal 122 using the same security policy as the access point 110.

In order for all the terminals in the BSS to be serviced through a wireless network, the BBS must install 5 access points supporting different security polices used by each terminal 121 to 125 in the same BSS, or all terminals 121 to 125 must support the same security policy (for example, TKIP and 802.1X EAP).

FIG. 2 is a block diagram illustrating a BSS configured with access points for supporting-different security policies.

Referring to FIG. 2, a first access point 211 uses WEP-40, a second access point 212 uses TKIP and 802.1X EAP, a fourth access point 214 uses WEP-104, a fifth access point 215 uses CCMP and 802.1X EAP, and a third access point 213 does not use a security policy.

Accordingly, network connection of a first terminal 221 using WEP-40 is made through the first access point 211 using the same security policy. Network connection of a second terminal 222 using TKIP and 802.1X EAP is made through the second access point 212. Network connection of a third terminal 223 not using a security policy is made through the third access point 213 not using a security policy. Network connection of a fourth terminal 224 using WEP-40 is made through the fourth access point 214 using the same security policy, and network connection of a fifth terminal 225 using CCMP and 802.1X EAP is made through the fifth access point 215 using the same security policy.

FIG. 3 is a block diagram illustrating a BSS configured with an access point for supporting a single security policy and a plurality of terminals.

As shown in FIG. 3, an access point 310 and all the terminals 321 to 325 in the BSS use WEP-40, and thereby all the terminals 321 to 325 may be connected through the same access point 310.

However, in the case of an authentication method for configuring BSS by disposing access points supporting different security policies in the same BSS, each access point must use a different frequency, and therefore efficiency of frequency usage is reduced. Additionally, in the case of an authentication method for configuring BSS by disposing one access point supporting only one security policy in the same BSS, all terminals must support the same security policy as the access point, and therefore diversified security services may not be provided to terminals supporting various security polices.

### SUMMARY OF THE INVENTION

The present invention has been made in view of the above problems, and an object of the present invention is to provide an access point and a method for supporting multiple authentication policies, enabling an authentication service for terminals using different authentication policies.

Another object of the present invention is to provide an access point and a method for supporting multiple authentication policies, enabling an authentication service for terminals using different authentication policies by supporting various authentication policies in the same BSS, and improving frequency usage efficiency by supporting various authentication policies through a single channel.

In order to achieve the above objects, the present invention provides an access point for a wireless network including at least one access point supporting authentication procedures for network connection to a plurality of terminals. An access point according to the present invention includes an authentication policy detector for detecting an authentication policy of a terminal from a signal transmitted by the terminal, a plurality of authentication modules for performing the authentication procedures corresponding to different authentication policies, and an authentication processor for performing an appropriate authentication procedure by selecting the corresponding authentication module according to the authentication policy detected by the authentication policy detector.

The authentication policy detector may include a mapping table for associating a media access control address of the terminal with an authentication policy used by the terminal. The authentication processor may include an authentication module selector for selecting the authentication module according to the authentication policy detected by the authentication policy detector, and an authentication server selector for selecting an authentication server according to the authentication policy detected by the authentication policy detector. The authentication module supports one authentication policy selected from WEP-40, WEP-104, 802.1X EAP+TKIP, 802.1X EAP+CCMP, and non-security.

In order to achieve the above and other objects, the present invention provides an authentication method for a wireless network including at least one access point supporting authentication procedures for network connection to a plurality of terminals. An authentication method according to the present invention includes detecting an authentication policy of a terminal from a signal transmitted by the terminal selecting the detected authentication policy from at least two authentication policies supported by the access point and performing an authentication procedure according to the selected authentication policy.

The step of detecting an authentication policy includes identifying whether the terminal is registered in an authentication policy mapping table, and detecting, if the terminal is registered in an authentication policy mapping table, an authentication policy mapped in the authentication policy mapping table. The authentication policy mapping table associates the media access control address of the terminal with the authentication policy used by the terminal. The authentication policy includes WEP-40, WEP-104, 802.1X EAP+TKIP, 802.X EAP+CCMP, and non-security.

In order to achieve the above objects, the present invention provides an authentication method for a wireless LAN system including at least one access point supporting authentication procedures for network connection to a plurality of terminals. An other authentication method according to the present invention includes receiving an association request message from a terminal, identifying, in response to the association request message, whether the terminal is registered in an authentication policy mapping table, detecting, if it is determined that the terminal is registered in an authentication policy mapping table, an authentication policy of the terminal from the authentication policy mapping table; and performing an authentication procedure according to the detected authentication policy of the terminal.

The authentication method further includes detecting, if the terminal is not registered in an authentication policy mapping table, an address and an authentication policy of the terminal from the association request message; and updating the authentication policy mapping table by newly registering the detected address and authentication policy of the terminal. The authentication policy mapping table associates the media access control (MAC) address of the terminal with the authentication policy used by the terminal. The authentication policy includes WEP-40, WEP-104, 802.1X EAP+TKIP, 802.1X EAP+CCMP, and non-security.

### BRIEF DESCRIPTION OF THE DRAWINGS

The above and other objects, features and advantages of the present invention will become more apparent from the following detailed description in conjunction with the accompanying drawings, in which:

FIG. 1 is a block diagram a conventional BSS configured with an access point and a plurality of terminals;

FIG. 2 is a block diagram illustrating a conventional BSS configured with access points for supporting different security policies;

FIG. 3 is a block diagram a conventional BSS configured with an access point for supporting a single security policy and a plurality of terminals;

FIG. 4 is a block diagram illustrating an access point for supporting multiple authentication policies according to the present invention;

FIG. 5A is a diagram illustrating an association request frame format including an RSN IE format for supporting multiple authentication policies according to the present invention;

FIG. 5B is a diagram illustrating a capability information field included in the frame body field of the association request frame format of FIG. 5A;

FIG. 5C is a diagram illustrating a suite selector format included in the RSN IE format of the association request frame of FIG. 5A;

FIG. 6 is a flow diagram illustrating a method for performing an association between a terminal and an access point using a method for supporting multiple authentication policies according to the present invention; and

FIG. 7 is a flow chart illustration a method for supporting multiple authentication policies according to the present invention.

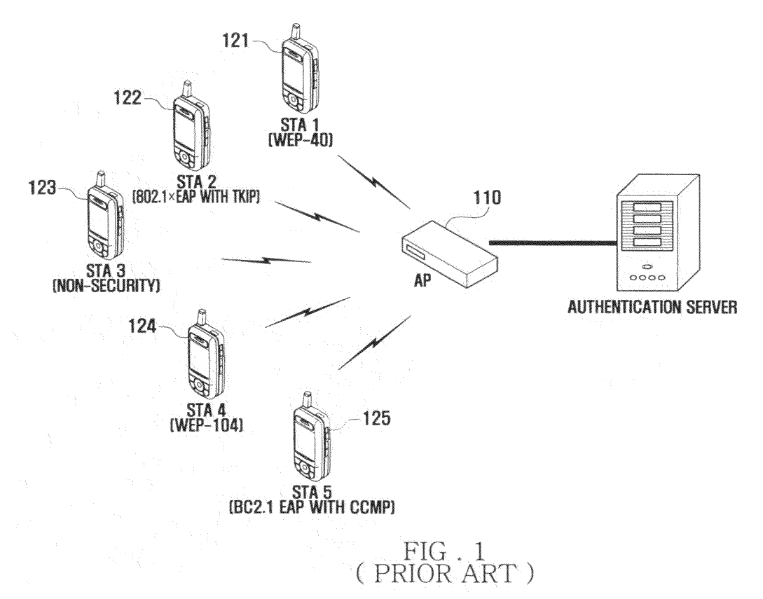

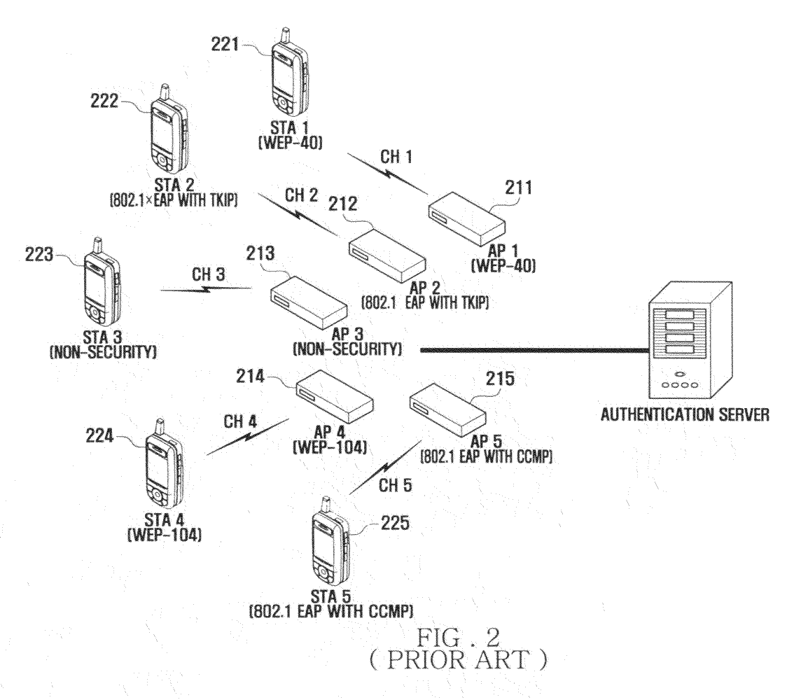

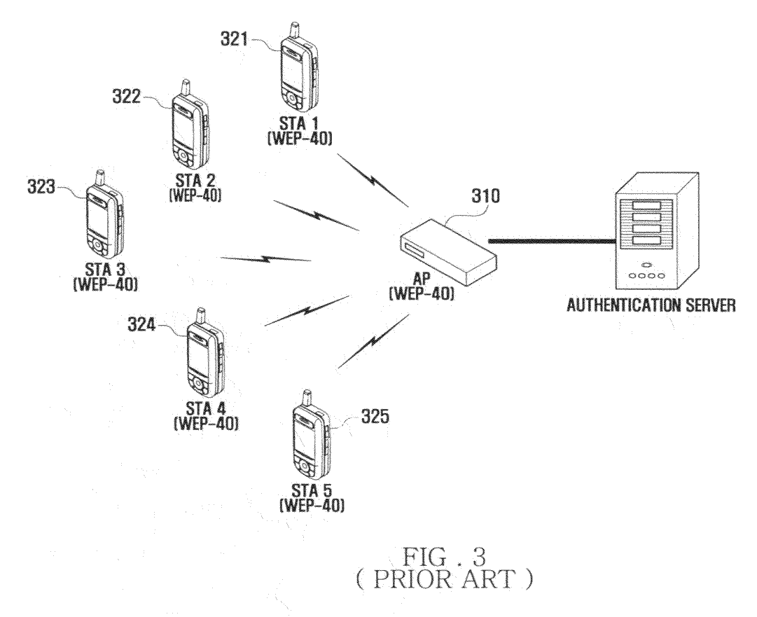

### DETAILED DESCRIPTION OF PREFERRED EMBODIMENTS

Hereinafter, preferred embodiments of the present invention are described in detail with reference to the accompanying drawings. The same reference numbers are used for the same or like components in the drawings. Detailed explanations for well-known functions and compositions may be omitted to avoid obscuring the subject matter of the present invention.

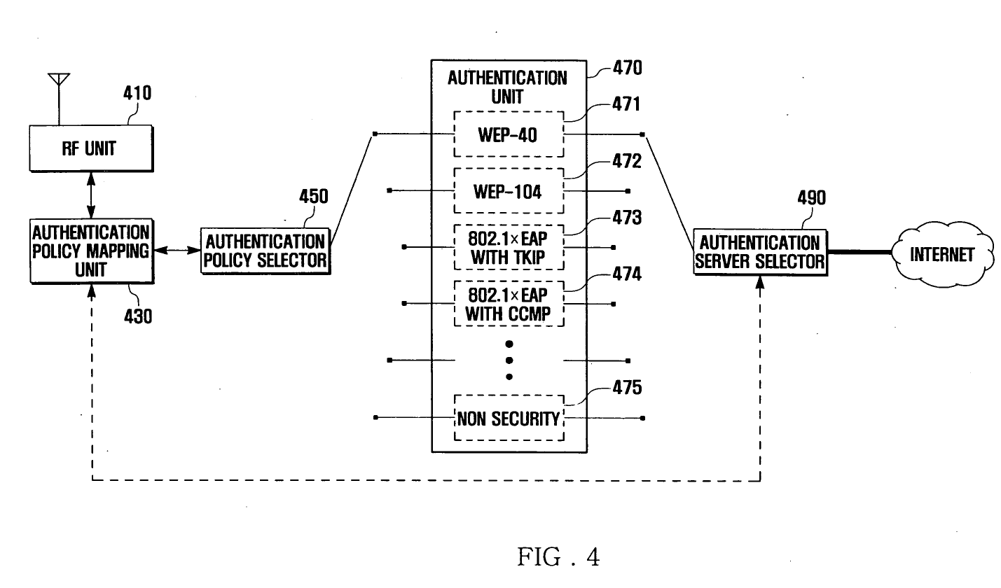

FIG. 4 is a block diagram showing a configuration of an access point for supporting multiple authentication policies according to the present invention.

Referring to FIG. 4, the access point for supporting multiple authentication policies includes an RF unit 410 for processing an RF signal transmitted and received through an antenna, an authentication unit 470 having a plurality of authentication modules for processing various authentication methods, an authentication mapping unit 430 for extracting an authentication method used by a terminal from the RF signal transmitted by the RF unit 410 by associating a media access control (MAC) address of the terminal with the authentication method, an authentication selector 450 for selecting an authentication module corresponding to the authentication method output by the authentication mapping unit 430, and an authentication server selector 490 for selecting an authentication server corresponding to the authentication method provided by the authentication mapping unit 430 and for performing an authentication procedure through the selected authentication server by using a signal output by the selected authentication module.

In more detail, the authentication mapping unit 430 generates an authentication policy mapping table, shown in Table 1 below, for associating the MAC address of a terminal with the authentication policy used by the terminal; identifies, if a signal is received, whether the corresponding terminal is registered in the authentication policy mapping table; and transmits, if information on the corresponding terminal is available, information on the corresponding authentication method to the authentication selector 450.

TABLE 1

| Authentication system | Authentication module address |
|---|---|
| WEP-40 | MAC Address 1 |
| WEP-104 | MAC Address 2 |
| 802.1X EAP with TKIP | MAC Address 3 |
| 802.1X EAP with CCMP | MAC Address 4 |
| Non-security | MAC Address 5 |

The authentication unit 470 includes a WEP-40 authentication module 471 for supporting a WEP-40 authentication policy, a WEP-104 authentication module 472 for supporting a WEP-104 authentication policy, an 802.1X EAP+TKIP authentication module 473 for supporting an 802.1X EAP+TKIP authentication policy, an 802.1X EAP +CCMP authentication module 474 for supporting an 802.1X EAP+CCMP authentication policy, and a non-security module 475 for supporting a non-security policy. The type and quantity of the authentication module(s) may be changed according to a communication environment.

Hereinafter, an operation method of the access point having the above configuration and supporting multiple authentication policies will be described.

Through a radio channel, communication between an access point and a terminal complies with the IEEE 802.11 protocol. The access point and the terminal use a shared key, and comply with the same authentication (or security) policy to share the same shared key.

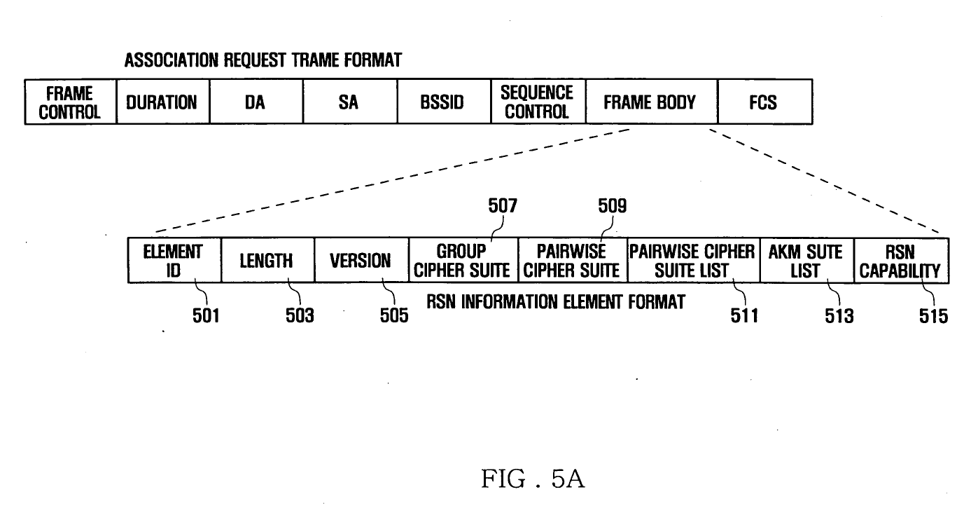

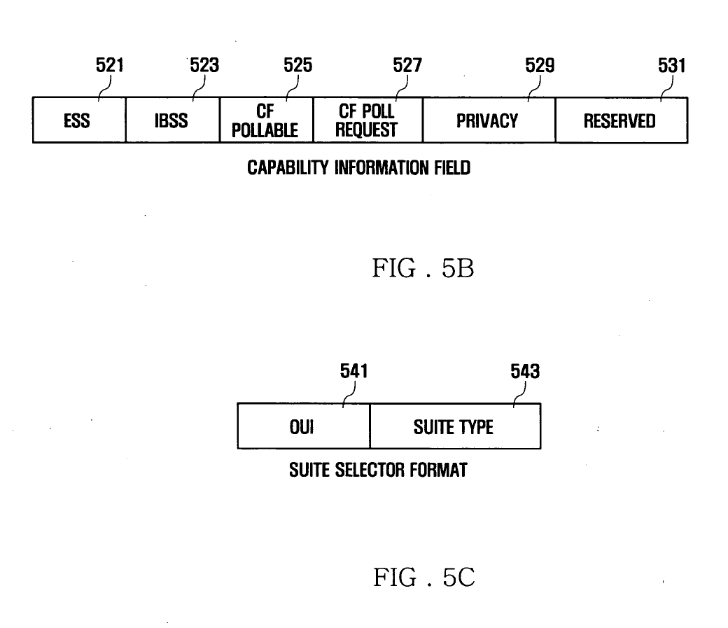

FIG. 5A is a diagram showing an association request frame format including an RSN IE format for supporting multiple authentication policies according to the present invention.

As shown in FIG. 5A, an RSN information element (IE) format for supporting multiple authentication policies is included in the association request frame format. The RSN IE format is configured with an element identifier field 501, length field 503, version field 505, group cipher suite field 507, pairwise cipher suite field 509, pairwise cipher suite list field 511, Authentication and Key Management (AKM) suite list field 513, and RSN capability field 515.

FIG. 5B is a diagram showing a capability information field included in the frame body field of the association request frame format of FIG. 5A.

As shown in FIG. 5B, the RSN capability information field is configured with an ESS field 521, IBSS field 523, contention-free (CF) pollable field 525, CF poll request field 527, privacy field 529, and reserved field 531.

When security is required in data communication, the value of the privacy field 529 is set to 1, and a cipher to be used in a BSS is indicated as a value of a suite selector field located in the group cipher suite field 507 or pairwise cipher suite field 509 of the RSN IE format.

FIG. 5C is a diagram showing a suite selector format included in the RSN IE format of the association request frame format of FIG. 5A. The suite selector format is configured with an OUI (organizationally unique identifier) field 541 and a suite type field 543. The capability information field and RNS IE format are included in a beacon message, probe response message, association request message, and re-association request message. According to the present invention, the access point for supporting multiple authentication policies broadcasts the types of cipher suite fields applicable to the access point in a round robin system through a beacon message. Terminals in the BSS try to associate with the access point by including their security information in the RSN IE.

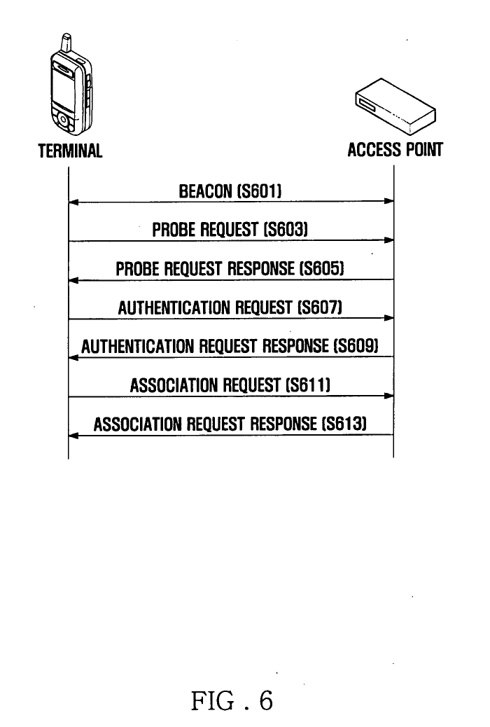

FIG. 6 is a flow diagram illustrating a method for forming an association between a terminal and an access point in a method for supporting multiple authentication policies according to the present invention.

Referring to FIG. 6, the access point 600 broadcasts a beacon message including RNS IE security parameters supported by the access point (600), such as CCMP, TKIP, WEP, and 802.1X EAP in step S601; and a terminal 602 receiving the beacon message transmits a probe request message to the access point 600 in response in step S603. When the probe request message is received, the access point 600 transmits to the terminal 602 a probe response message including security parameters supported by the access point 600, such as CCMP, TKIP, WEP, and 802.1X EAP in step S605. When the probe response message is received, the terminal 602 transmits an authentication request message to the access point 600 in step S607, and the access point 600 transmits an authentication response message to the terminal 602 in response in step S609. The terminal 602, having received the authentication response message, transmits an association request message including RSN IE security parameters supported by the terminal 602 to the access point 600 in step S611. The access point 602 transmits an association response message to the access point 600 in step S613, and thereby association setting is completed.

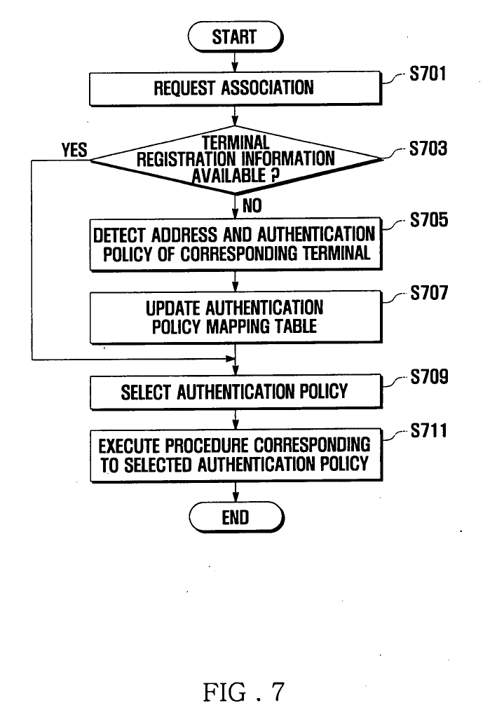

FIG. 7 is a flow chart illustrating a method for supporting multiple authentication policies according to the present invention.

Referring to FIG. 7, in the method for supporting multiple authentication policies, the access point firstly identifies reception of an association request message in step S701. The access point then determines, when the association is received, whether information on the terminal that transmitted the association request message is registered in an authentication policy mapping table in step S703. If it is determined that the information on the terminal is registered in an authentication policy mapping table, the access point selects an authentication policy associated with the MAC address of the terminal from the authentication policy mapping table in step S709, and performs an authentication procedure according to the selected authentication policy in step S711. A cipher to be used in a BSS may be identified by referring to a suite selector field located in the group cipher suite field 507 or pairwise cipher suite field 509 of the RSN IE format.

If it is determined that information on the terminal that transmitted the association request message is not registered in an authentication policy mapping table in step S703, the access point detects information on the address and authentication policy of the corresponding terminal from the association request message in step S705, and updates the authentication policy mapping table by newly registering the address and authentication policy of the terminal in the authentication policy mapping table in step S707. Terminal information for the new registration is collected from the capability information field of the RSN IE included in the association request message.

After updating the authentication policy mapping table, the access point selects the authentication policy of the terminal from the updated authentication policy mapping table in step S709, and performs an authentication procedure according to the selected authentication policy in step S711.

As described above, the access point and method for supporting multiple authentication policies according to the present invention may avoid duplication of network elements for authentication, by providing an authentication service for terminals using different authentication policies with a single access point. Additionally, the access point and method for supporting multiple authentication policies according to the present invention support various authentication policies through a single channel, and thereby frequency source usage efficiency is improved.

Although exemplary embodiments of the present invention have been described in detail hereinabove, it should be understood that many variations and modifications of the basic inventive concept herein described, which may appear to those skilled in the art, will still fall within the spirit and scope of the present invention as defined in the appended claims.

What is claimed is:

1. An access point for a wireless network, the wireless network having a plurality of terminals and at least one access point supporting authentication procedures for network connection to the terminals, comprising:
an authentication policy detector for detecting an authentication policy of a terminal from a signal transmitted by the terminal;
a plurality of authentication modules for performing the authentication procedures corresponding to different authentication policies; and
an authentication processor for performing an appropriate authentication procedure by selecting the corresponding authentication module according to the authentication policy detected by the authentication policy detector.

2. The access point of claim 1, wherein the authentication policy detector comprises a mapping table for relating the media access control address of the terminal to an authentication policy used by the terminal.

3. The access point of claim 2, wherein the authentication processor comprises:
an authentication module selector for selecting the authentication module according to the authentication policy detected by the authentication policy detector; and
an authentication server selector for selecting the authentication server according to the authentication policy detected by the authentication policy detector.

4. The access point of claim 1, wherein the authentication module supports one authentication policy selected from WEP-40, WEP-104, 802.1X EAP+TKIP, 802.1X EAP+CCMP, and non-security.

5. An authentication method for a wireless network, the wireless network having a plurality of terminals and at least one access point supporting authentication procedures for network connection to the terminals, comprising:
detecting an authentication policy of a terminal from a signal transmitted by the terminal;
selecting the detected authentication policy from a plurality of authentication policies supported by the access point; and
performing an authentication procedure according to the selected authentication policy.

6. The authentication method of claim 5, wherein the step of detecting the authentication policy comprises:
determining whether the terminal is registered in an authentication policy mapping table; and
detecting, if it is determined that the terminal is registered in an authentication policy mapping table, an authentication policy mapped in the authentication policy mapping table.

7. The authentication method of claim 6, wherein the authentication policy mapping table relates the media access control address of the terminal to the authentication policy used by the terminal.

8. The authentication method of claim 7, wherein the authentication policy comprises WEP-40, WEP-104, 802.1X EAP+TKIP, 802.1X EAP+CCMP, and non-security.

9. An authentication method for a wireless LAN system, the wireless LAN system having a plurality of terminals and at least one access point supporting authentication procedures for network connection with the terminals, comprising:
receiving an association request message from a terminal;
determining in response to the association request message, whether the terminal is registered in an authentication policy mapping table;
detecting, if it is determined that the terminal is registered in an authentication policy mapping table, an authentication policy of the terminal from the authentication policy mapping table; and
performing an authentication procedure according to the detected authentication policy of the terminal.

10. The authentication method of claim 9, further comprising:
detecting, if it is determined that the terminal is not registered in an authentication policy mapping table, an address and authentication policy of the terminal from the association request message; and
updating the authentication policy mapping table by newly registering the detected address and authentication policy of the terminal.

11. The authentication method of claim 10, wherein the authentication policy mapping table relates the media access control address of the terminal to the authentication policy used by the terminal.

12. The authentication method of claim 11, wherein the authentication policy comprises WEP-40, WEP-104, 802.1X EAP+TKIP, 802.1X EAP+CCMP, and non-security.
